(19) United States
(12) Patent Application Publication
(10) Pub. No.: US 2016/0295905 A1
(43) Pub. Date: Oct. 13, 2016

(54) Automatic pistachio huller

(71) Applicant: Tim Ray Vaughan, Pueblo West, CO (US)

(72) Inventor: Tim Ray Vaughan, Pueblo West, CO (US)

(21) Appl. No.: 14/999,110

(22) Filed: Mar. 30, 2016

Related U.S. Application Data
(60) Provisional application No. 62/178,469, filed on Apr. 10, 2015.

(51) Int. Cl. A23N 5/00

(52) U.S. Cl. CPC A23N 5/00

(57) ABSTRACT

A method and apparatus for automatically hulling freshly harvested pistachios are provided. An array of rollers is provided, wherein an alternating pattern of rollers is utilized; wherein rollers having a gritty surface alternate with rollers having a novel, perforated surface. The novel, perforated surface includes hull impact edges formed in preferably diamond shaped perforations in an expanded metal sleeve. These edges fracture the pistachio hulls into larger fragments, avoiding fouling of the huller by sticky mastic carried by the inner surface of the freshly harvested pistachios. The huller is thereby capable of operating with little or no water.

### CROSS REFERENCE TO RELATED APPLICATION

This application claims the benefit of and priority from U.S. provisional application Ser. No. 62/178,469, filed Apr. 10, 2015.

### BACKGROUND

The present invention pertains generally to automatic, high speed pistachio hullers. More particularly, the present invention provides such a huller which is highly resistant to fouling caused by the sticky mastic found in freshly harvested pistachios. The present invention also operates with little or no water.

A widely used prior art pistachio huller mechanism (shown and described further below) uses numerous fast rotating driven rollers coated with silicon carbide grit covered with an epoxy adhesive coating resulting in a gritty, abrasive surface. The coated rollers use abrasive action to scrub and abrade the hulls from the nuts. This abrasive scrubbing causes small bits of the hulls to break off and mix with the sticky, liquid content of the hulls, forming a sticky, glue-like substance. This substance sticks to the grit rollers and creates a smooth surface, reducing the effectiveness of the grit roller. This fouls the grit roller and is referred to herein as “blinding” the rollers. When the rollers become blinded, the pistachios are not hulled, and the efficiency of the huller drops substantially. Large amounts of water, approximately 50 gallons per minute, must be used to continuously spray the grit rolls to remove the sticky mastic.

The prior art also includes Nakhei-Nejad U.S. Pat. No. 6,422,137 B1 (the '137 patent). This mechanism utilizes rolls made of resilient material such as rubber, that are spring loaded to provide a constant pressure. This hull removal operation is dependent on friction between the pistachio hull and the rollers to peel the hull away, in relatively small pieces, from the pistachio. This prior art '137 patent mechanism is inherently prone to fouling by the sticky mastic gumming up the spring mounting of the satellite rollers.

The McFarland et al. U.S. Pat. No. 4,034,665 (the '665 patent) prior art huller inherently requires substantial amounts of water to operate (Column 7, line 63-Column 8, line 59). This mechanism uses opposing teeth (FIG. 9) having square cross-sections (Column 2, lines 65-68). The teeth are rubber or other resilient material. These rubber or resilient teeth become worn and must be replaced (Column 3, lines 1-3).

There is a dire need for a high speed automatic pistachio huller which is resistant to fouling, durable and capable of operating efficiently with little or no water, since most pistachios are grown in regions in which water is scarce and/or expensive.

### BRIEF SUMMARY OF INVENTION

The present invention provides a novel method and apparatus whereby the pistachio hulls are broken into relatively large pieces compared with the prior art. The relatively large hull fragments retain the sticky mastic carried on the fragment inner surface. Virtually all of the sticky mastic is disposed of together with the large hull fragments. The result is that the machinery does not become “blinded” by the sticky mastic. As a consequence, little or no water is necessary to continuously wash the sticky mastic off the surfaces used by the prior art to either abrade the hulls or to resiliently break the hulls into small pieces.

The '137 patent describes a machine wherein the pistachios travel between rollers that are spring loaded as part of the operation. In contrast, the present invention allows only the hulls to pass through the rolls. The pistachio stays contained within the rolls; they enter at one end of the machine, and exit the other end.

As shown and described below, the present invention preferably utilizes an expanded metal perforated sleeve to impact the hull, breaking it into large chunks. We have found that by impacting the hulls with a hard, metallic edge as each hull is “held” by a frictional surface, the hulls can be broken into much larger fragments than known in the prior art. The larger hull fragments allow the system to operate with little or no water; this is very significant, since pistachios are generally grown in arid climates where water is limited and/or expensive.

A further advantage is that widely used prior art machines abrade the hull into small pieces, with an unfortunate side effect of abrading a portion of the edible nut along with the hull. This results in a loss of edible nut meat. This loss is avoided with the present invention.

A primary object of the invention is to provide a method and apparatus for automatically hulling pistachios whereby little or no water is required to wash sticky mastic off the machine elements utilized to separate the hull from the nut.

A further object is to provide a novel technique for automatically separating pistachio hulls from the nuts whereby a hard, metallic edge is utilized to impact the hull, while the hull is momentarily “held” by a frictional, or gritty surface. The impact is sufficiently strong to break the hull into relatively large fragments as compared with the prior art.

A further object is that by preventing the rollers from being blinded, the present invention increases the efficiency of the huller, since rollers that become blinded do not properly remove hulls from the nuts.

Other objects and advantages will become apparent from the following description and drawings.

### BRIEF DESCRIPTION OF THE DRAWINGS

FIG. 1 is a perspective view of a prior art pistachio huller;

FIG. 2 is a perspective view of the discharge end of the huller shown in FIG. 1;

FIG. 3 is a perspective of a prior art grit roll used in the huller shown in FIGS. 1 and 2;

FIG. 4A is a perspective view of a preferred embodiment of a novel improved roller having a perforated, non-resilient sleeve;

FIG. 4B is a plan view of a single perforation of the new roller of FIG. 4A;

FIG. 4C is a section on the line 4C-4C of FIG. 4B;

FIG. 5 is a side elevational view of a portion of the new roller shown in FIG. 4A;

FIG. 6 is a perspective view of the improved huller using the improved rollers of FIG. 4A together in an alternating pattern with the known rollers shown in FIG. 3;

FIG. 7 is a perspective view of the discharge end of the huller shown in FIG. 6;

FIG. 8A is a “concept” sketch, showing how the improved roller cooperates with the known roller to fracture a pistachio into large fragments.

FIG. 8B shows how the fractured hull with sticky mastic lining is disposed of, and how the edible nut is thrown upwardly to proceed to the discharge end of the huller, and

FIG. 9 illustrates various perforation patterns that may be utilized.

### DETAILED DESCRIPTION OF THE DRAWINGS

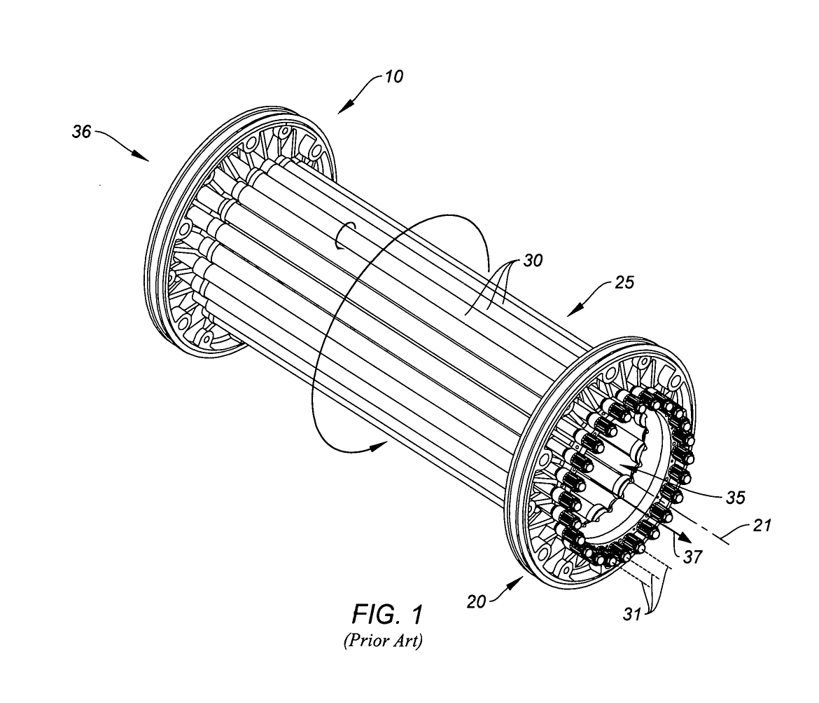

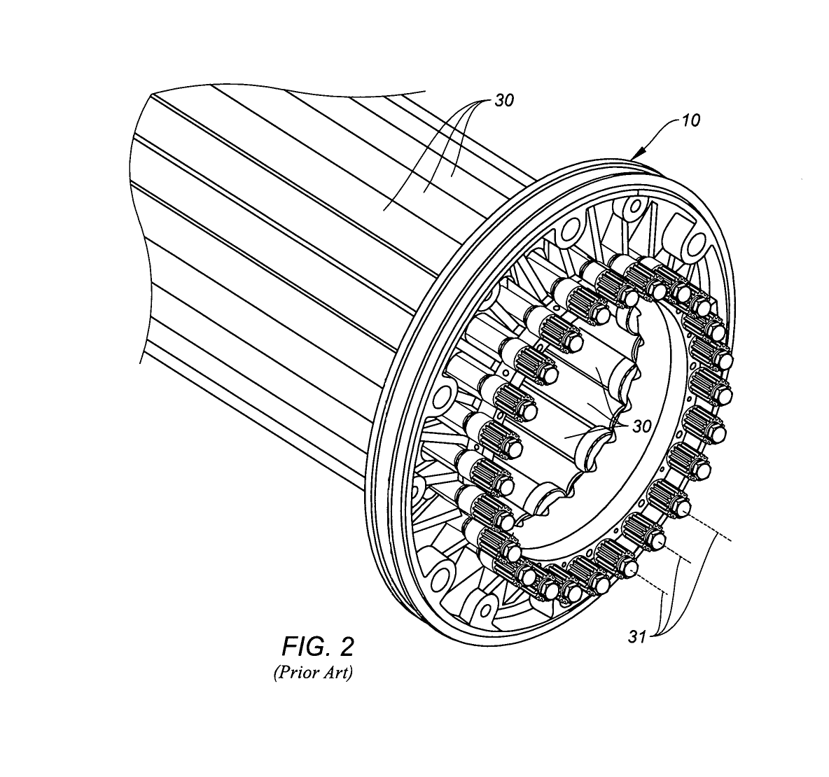

FIGS. 1 and 2 illustrate an existing, prior art, Magnuson NF Peeler shown generally at 10. Peeler or huller 10 is an automatic, high speed pistachio hulling machine for hulling freshly harvested pistachios. The freshly harvested pistachios have a sticky mastic lining between the hull and nut portion of each pistachio, as shown and described below. Cylindrical cage 20 comprises an array 25 of driven cylindrical rollers 30 which rotate about parallels, spaced apart axes 31. Cage 20 has an internal chamber 35 having an inlet 36 into which unhulled, freshly harvested pistachios are fed, and an outlet 37 through which hulled pistachios are passed. All rollers in array 30 rotate about their axes in the same rotational direction. Cage 20 rotates around a preferably horizontal axis 21 and is driven by means known in the art. The rotation of cage 20 causes pistachios to tumble inside chamber 35. The tumbling pistachios fall downwardly onto the rollers of array 30 to be hulled. Slowly rotating cage 20 contains twenty four fast rolling grit rolls 30.

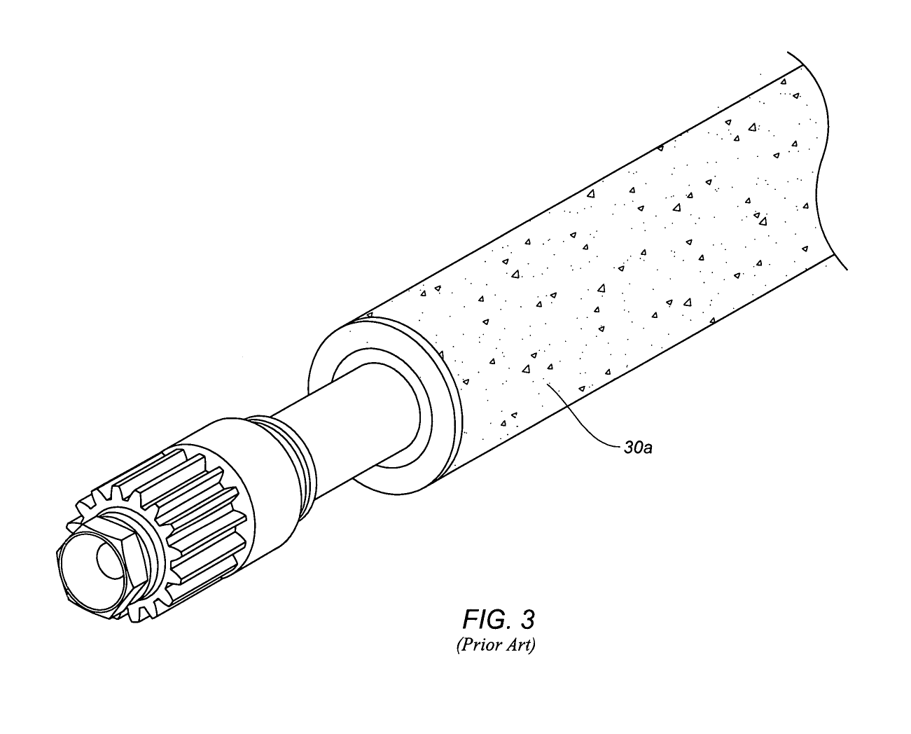

FIG. 3 illustrates a single prior art grit roll 30a used in huller 10 of FIGS. 1 and 2. The surface is a silicon carbide grit with an epoxy coating. This gritty surface becomes “blinded” as noted above by the sticky mastic contained in freshly harvested pistachios. As adjacent grit rolls abrade the pistachios, small bits of the hull are worn away and mix with the sticky mastic.

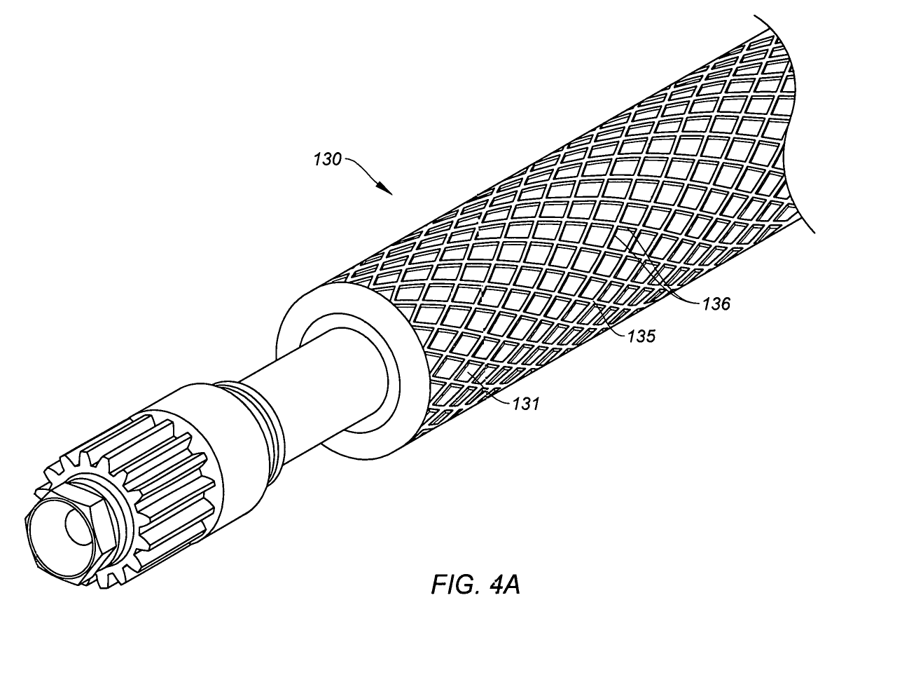

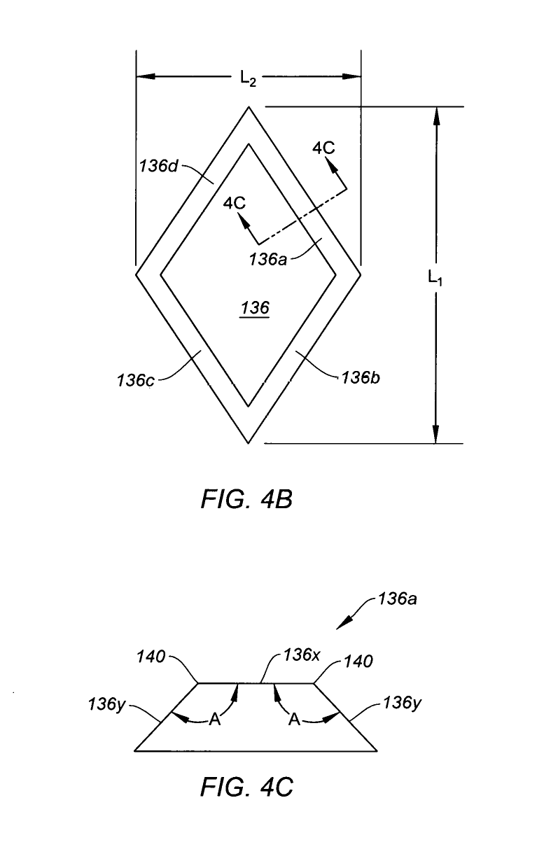

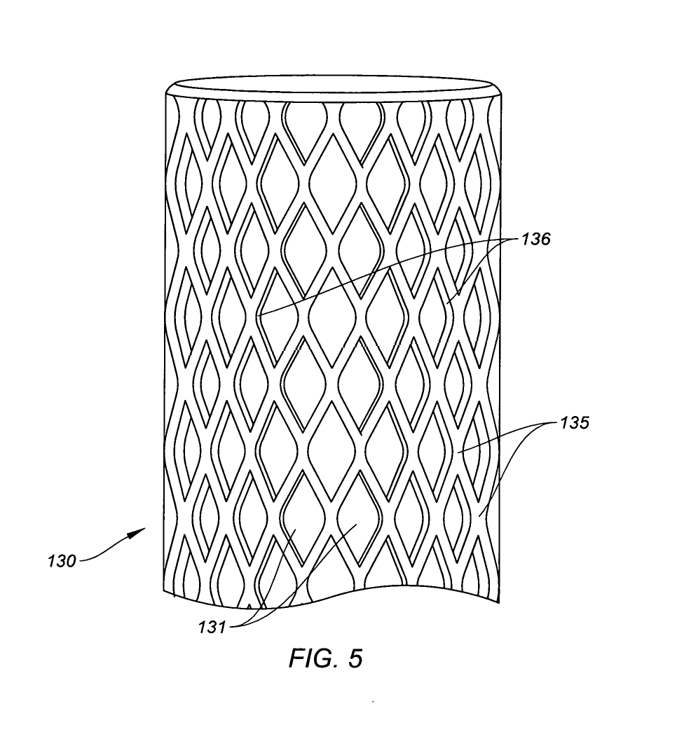

FIGS. 4A-4C and 5 illustrate a preferred embodiment of novel roller 130. As shown in FIG. 4A plain cylindrical roller 131 is covered, usually by welding, with an expanded metal sleeve 135 of a perforated metal or other hard, non-resilient material. The multiple perforations 136 form a geometric pattern, preferably having a diamond shape. The edges of the perforations form hull impact edges 140 having beveled corners which fracture the fibrous material of the pistachio hull, as contrasted with abrading the hull. Fracturing the hull creates much larger fragments or pieces of the hull with greater edible nut mass being removed, compared with abrasion of the hull. The centrifugal force of the spinning roller 130 quickly clears the larger fragments from the surface of sleeve 135. The sticky mastic lining adheres to these larger hull fragments and does not adhere to the rollers. The larger fragments either eliminate or greatly reduce the amount of the sticky mastic that sticks to the roll; the roll is resistant to “blinding.”

FIG. 4B is a plan view of a single diamond shaped perforation 136, formed in sleeve 135. Each perforation 136 is bounded by four arms 136a-136d. The long axis of L₁ of the perforation 136 is preferably between 20-25 millimeters. It is also parallel with the axis of rotation of roller 130. The short axis L₂ of perforation 136 is preferably between 10-13 millimeters, about one-half the length of the long axis. The short axis is also preferably approximately one-half the length of a typical unhulled pistachio.

FIG. 4C is a section on the line 4C-4C in FIG. 4B. FIG. 4C illustrates one arm 136a having two hard hull impact edges 140 which are beveled corners of arm 136a. All arms of all perforations of sleeve 135 are identical. The hull impact edges 140 are formed between the top of 136x of arm 136a and the sidewalls 136y of arm 136a. The angle A formed by the top surface 136x and sidewalls 136y is a beveled corner angle (which constitutes a hull impact edge) preferably between 125° and 145°, and most preferably between 130° and 140°.

FIG. 5 is a side view of a portion of roller 130 of FIG. 4.

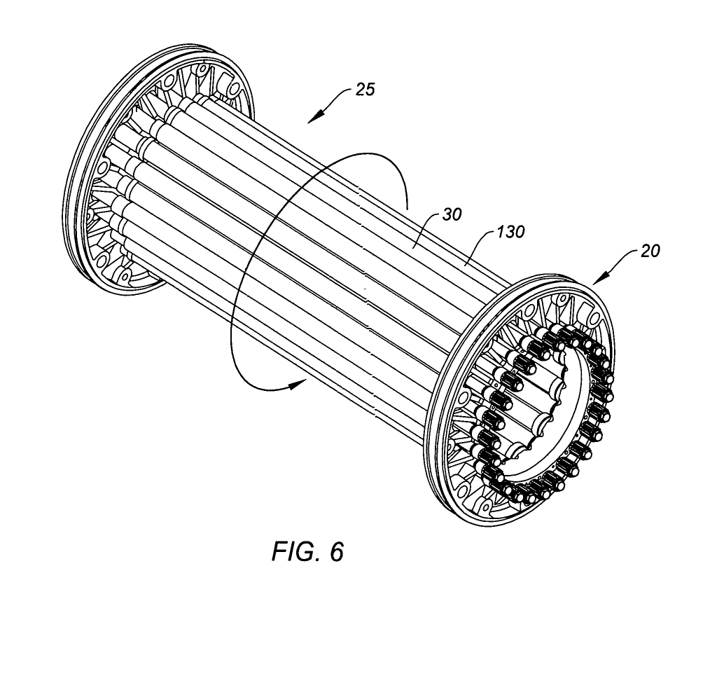

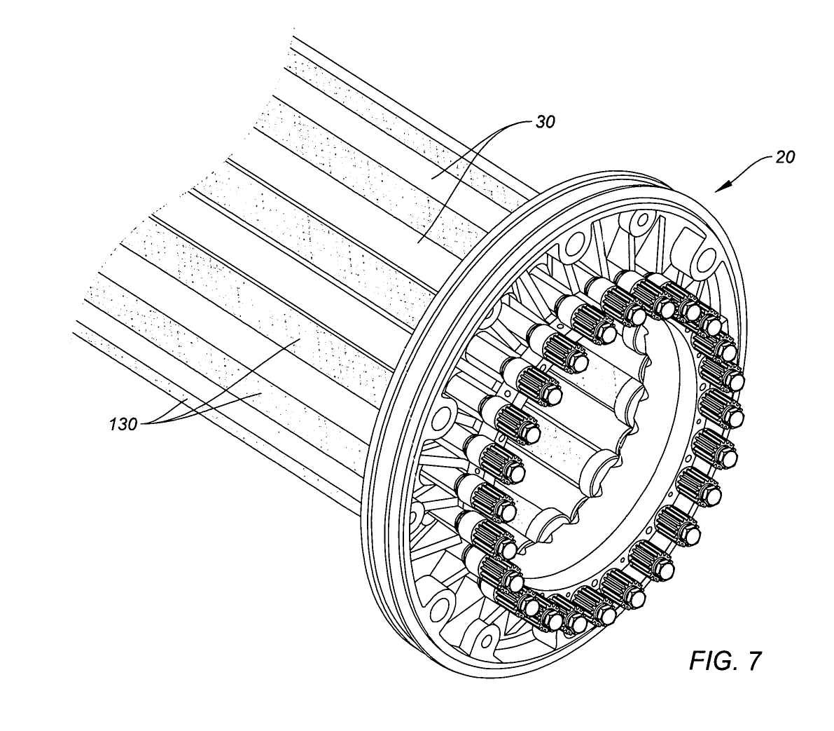

FIGS. 6 and 7 illustrate how the new perforated metallic rolls 130 are preferably used in an alternating pattern with the prior art grit rolls 30. All rolls are rotated in the same direction. The preferred embodiment of the invention modifies and significantly improves the prior art huller shown in FIGS. 1-3 by replacing one half of the prior art grit rollers with the new roller design shown and described in FIGS. 4A-9. The array 25 of rollers 30 and 130 forming cage 20 includes a first subset of prior art rollers described above, each having a gritty surface. The array 25 also includes a second subset of the improved rollers 130. The two subsets are equal in number and form an alternating pattern of rollers around the periphery of cage 20 wherein each prior art roller 30 in the first subset has an improved roller 130 of the second subset adjacent to it.

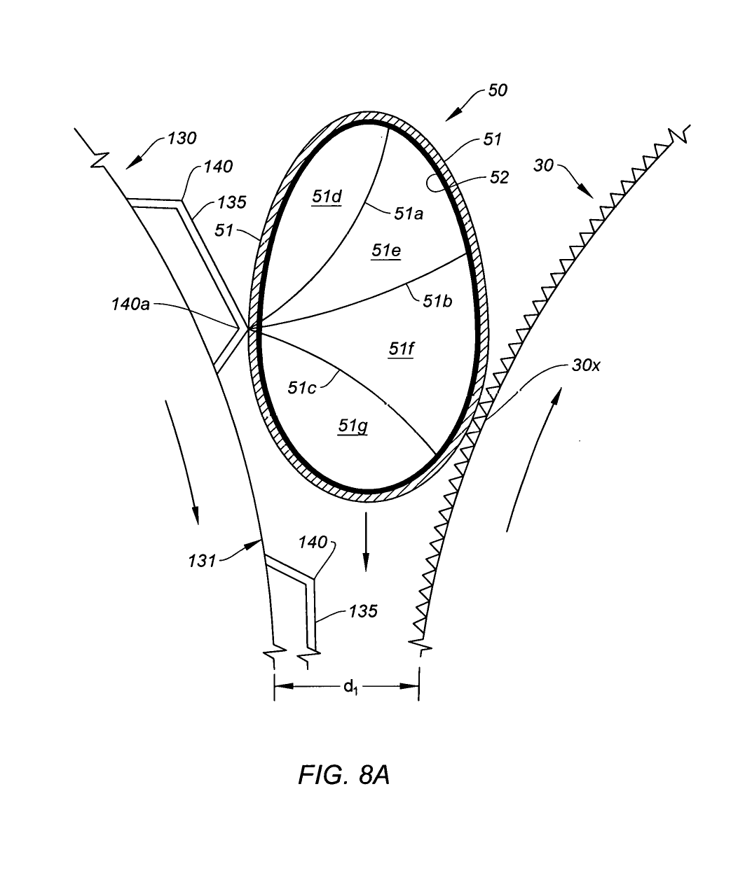

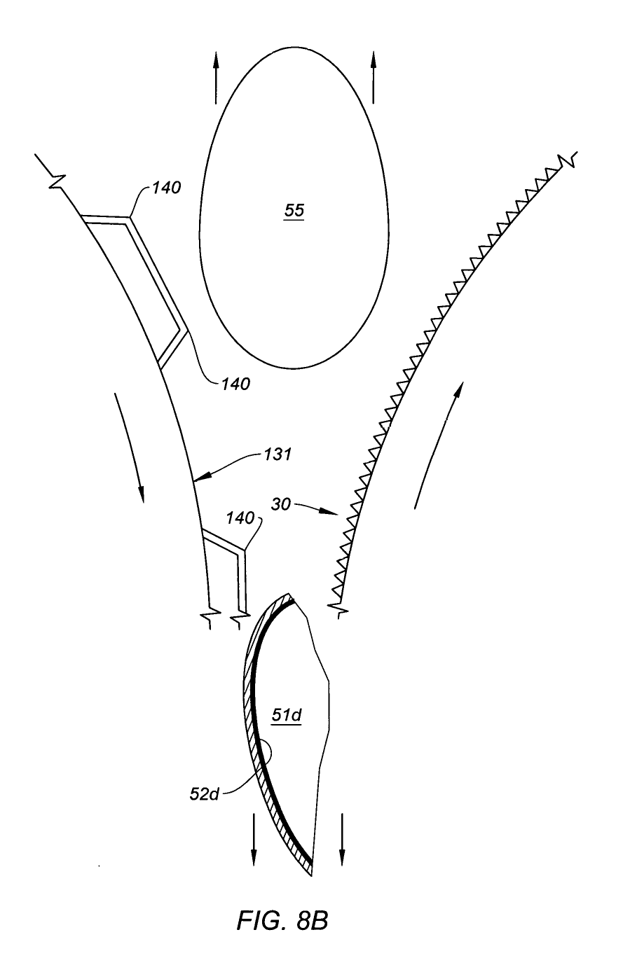

FIGS. 8A and 8B illustrates the “concept” of the present invention. FIGS. 8A and 8B are not to scale, and are exaggerated to illustrate the overall concept of the invention. In FIG. 8A, unhulled pistachio 50 has been tumbled and is moving downwardly between grit roll 30 and improved roll 130. Pistachio 50 has a fibrous hull 51, a sticky mastic lining 52 which is adhered to hull 51, and an edible nut 55 not visible in FIG. 8A.

As shown in FIG. 8A, roller 130 includes plain roller 131 which carries novel sleeve 135, preferably metal, with preferably diamond shaped perforations 136 shown best in FIGS. 4 and 5. The hard hull impact edges 140 are formed in sleeve 135. Hull impact edge 140a in FIG. 8A is shown as it contacts hull 51. Grit roll 30 momentarily grips or holds hull 51 at point 30x, and hull 51 is fractured along lines 51a, 51b and 51c breaking the portion of hull 51 visible in FIG. 8A into four fragments 51d, 51e, 51f and 51g. The fragments 51d-51g separate from the nut 55 as shown in FIG. 8B.

FIG. 8B illustrates how hull fragment 51d, with sticky mastic lining fragment 52d attached, falls downwardly by gravity between rollers 30 and 131 and is disposed of as waste. The other fragments also do the same as 51d. Edible nut 55 is thrown upwardly by the gritty surface of roller 30 and is then driven toward the discharge end of chamber 35 by an auger, not shown for clarity. Said auger is known in the art. Since the sticky mastic adheres to the large fragments, it does not adhere to the rollers.

As shown best in FIG. 8A, the distance “d₁” between the surfaces of adjacent rollers 130 and 30 forms a gap that is sufficiently small to prevent hulled pistachios (the nut itself) from passing downwardly through the gap without being damaged. The distance “d₁” is measured from the surface of plain roller 131, not from the surface of sleeve 135, to the surface of roller 30. The distance “d₁” is between 2-4 millimeters.

As noted above, an important aspect of the improved huller is that it is not necessary to use water to rinse the sticky mastic off of rollers 130 and/or 30, since the mastic adheres to the large hull fragments.

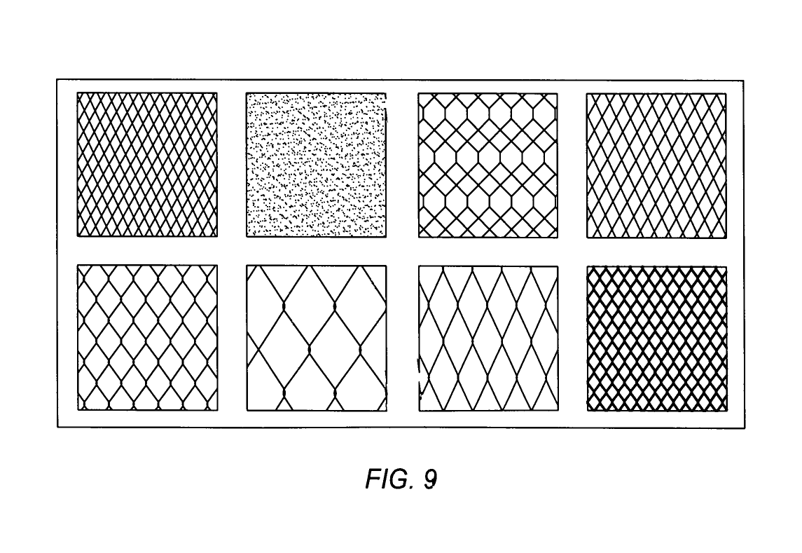

FIG. 9 illustrates various geometric perforation patterns that may be utilized. The perforated metal stock used to make sleeve 135 may be of various gauges (thickness), may have various size and shape openings in the material, may be made of various materials, may have edges forming various beveled corner angles with the surface of the core. Furthermore, the size of the core carrying the perforated stock may be of various sizes.

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments and with various modifications suited to the particular use contemplated.

1. An automatic, high speed pistachio hulling machine for hulling freshly harvested pistachios which each have a sticky mastic lining between the hull and the nut portion of each pistachio, wherein an array of driven cylindrical rollers rotate about parallel spaced apart axes, wherein said array forms a cylindrical cage having an internal chamber, said internal chamber having an inlet into which unhulled pistachios are fed and an outlet through which hulled pistachios are passed wherein said cage rotates about an axis to tumble pistachios in said chamber, wherein all of said rollers rotate about their axes in the same rotational direction and wherein said cylindrical cage rotates about an axis to continuously tumble pistachios characterized by:
said array of rollers includes a first subset of rollers and a second subset of rollers, said cage comprises an equal number of rollers of said first subset and second subset and wherein said cage has an alternating pattern of rollers around the periphery of said cage wherein each roller of said first subset has a roller of said second subset adjacent to it,
each roller of said first subset has a gritty surface, and
each roller of said second subset has a non-resilient surface with multiple perforations, wherein said perforations have hull impact edges,
wherein each of said array of rollers are positioned to form a gap between adjacent roller surfaces sufficiently small to prevent hulled pistachios from passing through said gap,
whereby as an unhulled pistachio is tumbled into the space between any pair of said rollers, as the hull of the pistachio contacts one of said hull impact edges of a roller of second subset, the opposite side of said hull is momentarily gripped or held by said gritty surface of the adjacent roller of said first subset, whereby said hull impact edge fractures the hull of said pistachio into sufficiently large fragments that said sticky mastic layer adheres to each large hull fragment and does not adhere to any of said rollers.

2. The hulling machine of claim 1 wherein it is not necessary to use water to rinse said sticky mastic off said rollers.

3. The hulling machine of claim 3 wherein said non-resilient surface with multiple perforations is an expanded metal sleeve.

4. The hulling machine of claim 1 wherein said multiple perforations are diamond shaped.

5. The hulling machine of claim 1 wherein said hull impact edges are beveled corner angles of between 125° and 145°.

6. The hulling machine of claim 1 wherein said hull impact edges are beveled corner angles of between 130° and 140°.

7. The hulling machine of claim 1 wherein said gap between adjacent roller surfaces is between 2 and 4 millimeters.

8. A method of automatically hulling pistachios at high speed, wherein said pistachios have a sticky mastic layer between the hull and the nut, wherein an array of driven cylindrical rollers rotate about parallel spaced apart axes, wherein said array forms a cylindrical cage having an internal chamber, said internal chamber having an inlet into which unhulled pistachios are fed and an outlet through which hulled pistachios are passed wherein said cage rotates about an axis to tumble pistachios in said chamber wherein each of said array of rollers rotates about its axis in the same rotational direction and wherein said cylindrical cage rotates about an axis to continuously tumble pistachios characterized by,
tumbling unhulled pistachios in said chamber to cause said pistachios to move downwardly into a gap between first and second adjacent rollers, said gap being sufficiently small to prevent the nut portion of each pistachio from passing through said gap without being damaged,
gripping the hull of each pistachio with a gritty, frictional surface of said first roller,
impacting the hull of each pistachio with a hard, hull impact edge formed in the surface of said second roller,
wherein said impact causes said hull to fracture into sufficiently large fragments so that said sticky mastic layer adheres to said large hull fragments and the hull separates from the nut of each pistachio,
disposing of said large hull fragments with said sticky mastic layer attached, whereby said sticky mastic does not adhere to any of said rollers, thereby eliminating the need to utilize water to rinse said sticky mastic from said rollers.

9. The method of claim 8 wherein said hull impact edge is formed in a non-resilient, perforated sleeve carried by said second roller.

10. The method of claim 9 wherein said perforations are diamond shaped.

11. The method of claim 8 wherein said gap is between 2 and 4 millimeters.

12. The method of claim 8 wherein said hull impact edges are beveled corner angles between 130° and 140°.
